(19) United States
(12) Patent Application Publication
(10) Pub. No.: US 2021/0144588 A1
(43) Pub. Date: May 13, 2021

(54) Data Transmission Method, Transmitting End Device, and Receiving End Device

(71) Applicant: GUANGDONG OPPO MOBILE TELECOMMUNICATIONS CORP., LTD., Dongguan, Guangdong (CN)

(72) Inventor: Hai Tang, Dongguan, Guangdong (CN)

(21) Appl. No.: 16/623,324

(22) PCT Filed: Aug. 11, 2017
(86) PCT No.: PCT/CN2017/097243

§ 371 Date: Dec. 16, 2019

(51) Int. Cl. H04W 28/08; H04W 28/24; H04W 28/02; H04W 76/27

(52) U.S. Cl. CPC H04W 28/085; H04W 76/27; H04W 28/0268; H04W 28/24

(57) ABSTRACT

A data transmission method, a transmitting device and a receiving device are provided. The method includes: a transmitting device switches a DRB corresponding to a first QoS flow from a first DRB to a second DRB; and the transmitting device sends unsent data packets in the first QoS flow to a receiving device through the second DRB.

### CROSS-REFERENCE TO RELATED APPLICATION(S)

This application is a 371 application of international Application No. PCT/CN2017/097243, filed on Aug. 11, 2017, the entire disclosure of which is hereby incorporated by reference.

### TECHNICAL FIELD

The present application relates to the field of communication, and more particularly, to a data transmission method, a transmitting device, and a receiving device.

### BACKGROUND

In a New Radio (NR) Access Technology system, a Service Data Adaptation Protocol (SDAP) layer is added to a radio access network to accomplish mapping of a Quality of Service (QoS) flow to a Data Radio Bearer (DRB). At present, the radio access network establishes a default DRB for different QoS flows. However, the default DRB cannot meet data transmission requirements of different QoS flows. Therefore, how to improve the data transmission of the QoS flow is an urgent problem to be solved.

### SUMMARY

Implementations of the present application provide a data transmission method, a transmitting device and a receiving device.

In a first aspect, an implementation of the present application provides a data transmission method, including: switching, by a transmitting device, a Data Radio Bearer (DRB) corresponding to a first Quality of Service (QoS) flow from a first DRB to a second DRB; and sending, by the transmitting device, unseat data packets in the first Quality of Service flow to a receiving device through the second DRB.

Optionally, the transmitting device may be a terminal device or a network device.

Optionally, when the transmitting device is a terminal device, the receiving device is a network device, or when the transmitting device is a network device, the receiving device is a terminal device.

It should be understood that the second DRB is more suitable for transmission of the first Quality of Service flow.

Optionally, in an implementation of the first aspect, before the transmitting device switches the DRB corresponding to the first Quality of Service flow from the first DRB to the second DRB, the method further includes: receiving, by the transmitting device, indication information, wherein the indication information is used for indicating switching the DRB corresponding to the first Quality of Service flow from the first DRB to the second DRB.

Optionally, at this case, the transmitting device may be a terminal device.

Optionally, in an implementation of the first aspect, the indication information is a Radio Resource Control (RRC) signaling or a Reflective Quality of Service (RQoS), wherein the RQoS is determined according to an Identity (ID) of a data packet received on the second DRB.

Optionally, in an implementation of the first aspect, before the transmitting device switches the DRB corresponding to the first Quality of Service flow from the first DRB to the second DRB, the method further includes: sending, by the transmitting device, at least one data packet in the first Quality of Service flow through the first DRB.

Optionally, in an implementation of the first aspect, before the transmitting device sends the at least one data packet in the first Quality of Service flow through the first DRB, the method further includes: adding, by the transmitting device, first identity information to a header of a last data packet in the at least one data packet, wherein the first identity information is used for indicating that the last data packet is a last data packet sent by the transmitting device through the first DRB.

Optionally, in an implementation of the first aspect, the method further includes: sending, by the transmitting device, a first identity packet after sending the at least one data packet, wherein the first identity packet is used for indicating that a previous data packet of the first identity packet is a last data packet corresponding to the first DRB.

Optionally, in an implementation of the first aspect, before the transmitting device sends the unsent data packets to the receiving device through the second DRB, the method further includes: adding, by the transmitting device, second identity information to a header of a first data packet in the unsent data packets, wherein the second identity information is used for indicating that the transmitting device sends a data packet in the first Quality of Service flow through the first DRB before sending the first data packet.

Optionally, in an implementation of the first aspect, before the transmitting device sends the unsent data packets to the receiving device through the second DRB, the method further includes: sending, by the transmitting device, a second identity packet to the receiving device through the second DRB, wherein the second identity packet is used for indicating that the transmitting device sends a data packet in the first Quality of Service flow through the first DRB before sending the second identity packet.

Optionally, in an implementation of the first aspect, a QoS Class Identifier (QCI) of a data packet transmitted on the second DRB is superior to a QCI of a data packet transmitted on the first DRB.

In a second aspect, an implementation of the present application provides a data transmission method, including: determining, by a receiving device, that a Data Radio Bearer (DRB) corresponding to a first Quality of Service (QoS) flow is switched from a first DRB to a second DRB; receiving, by the receiving device, multiple data packets in the first Quality of Service flow sent by a transmitting device through the second DRB; and buffering, by the receiving device, the multiple data packets.

Optionally, in an implementation of the second aspect, before the receiving device determines that the DRB corresponding to the first Quality of Service flow is switched from the first DRB to the second DRB, the method further includes: receiving, by the receiving device, indication information, wherein the indication information is used for indicating that the DRB corresponding to the first Quality of Service flow is switched from the first DRB to the second DRB.

Optionally, at this case, the receiving device may be a terminal device.

Optionally, in an implementation of the second aspect, the indication information is a Radio Resource Control (RRC) signaling or a reflective quality of service, wherein the reflective quality of service is determined according to an Identity (ID) of a data packet received on the second DRB.

Optionally, in an implementation of the second aspect, a header of a first data packet in the multiple data packets includes first identity information, wherein the first identity information is used for indicating that the transmitting device sends a data packet in the first Quality of Service flow through the first DRB before sending the first data packet; the receiving device determines that the multiple data packets need to be buffered, which includes: determining that the multiple data packets need to be buffered according to the first identity information.

Optionally, in an implementation of the second aspect, before the receiving device receives the multiple data packets, the method further includes: receiving, by the receiving device, a first identity packet through the second DRB, wherein the first identity packet is used for indicating that the transmitting device sends a data packet in the first Quality of Service flow through the first DRB before sending the first identity packet; wherein determining, by the receiving device, that the multiple data packets need to be buffered, includes: determining that the multiple data packets need to be buffered according to the first identity packet.

Optionally, in an implementation of the second aspect, the method further includes: receiving, by the receiving device, at least one data packet in the first Quality of Service flow sent by the transmitting device through the first DRB, wherein a header of a last data packet in the at least one data packet includes second identity information, the second identify information is used for indicating that the last data packet is a last data packet sent by the transmitting device through the first DRB; transmitting, by the receiving device, the multiple data packets received through the second DRB and the at least one data packet received through the first DRB according to the second identity information.

Optionally, in an implementation of the second aspect, the method further includes: receiving, by the receiving device, at least one data packet in the first Quality of Service flow sent by the transmitting device through the first DRB; receiving, by the receiving device, a second identity packet sent by the transmitting device through the first DRB, wherein the second identity packet is used for indicating that a previous data packet of the second identity packet is a last data packet sent by the transmitting device through the first DRB; and transmitting, by the receiving device, the multiple data packets received through the second DRB and the at least one data packet received through the first DRB according to the second identity packet.

Optionally, in an implementation of the second aspect, a QoS Class Identifier (QCI) of a data packet transmitted on the second DRB is superior to a QCI of a data packet transmitted on the first DRB.

In a third aspect, an implementation of the present application provides a transmitting device, which may execute a module or unit of the method in the first aspect or any optional implementation of the first aspect.

In a fourth aspect, an implementation of the present application provides a receiving device, which may execute a module or unit of the method in the second aspect or any optional implementation of the second aspect.

In a fifth aspect, a transmitting device is provided, including a processor, a memory, and a communication interface. The processor is connected with the memory and the communication interface. The memory is used for storing instructions, and the processor is used for executing the instructions, and the communication interface is used for communicating with other network elements under the control of the processor. When the processor executes the instructions stored in the memory, the execution causes the processor to execute the method in the first aspect or any optional implementation of the first aspect.

In a sixth aspect, a receiving device is provided, including a processor, a memory, and a communication interface. The processor is connected with the memory and the communication interface. The memory is used for storing instructions, and the processor is used for executing the instructions, and the communication interface is used for communicating with other network elements under the control of the processor. When the processor executes the instructions stored in the memory, the execution causes the processor to execute the method in the second aspect or any optional implementation of the second aspect.

In a seventh aspect, a computer storage medium is provided, wherein the computer storage medium is used for storing program codes for indicating a computer to execute instructions of the method in the first aspect or any optional implementation of the first aspect.

In an eighth aspect, a computer storage medium is provided, wherein the computer storage medium is used for storing program codes for indicating a computer to execute instructions of the method in the second aspect or any optional implementation of the second aspect.

In a ninth aspect, a computer program product including instructions is provided, wherein when the instructions are executed on a computer, to cause the computer to perform the methods described in the above aspects.

### BRIEF DESCRIPTION OF DRAWINGS

FIG. 1 is a wireless communication system to which an implementation of the present application is applied.

FIG. 2 is a schematic diagram of mapping of QoS flows to DRBs according to an implementation of the present application.

FIG. 3 is a schematic flow chart of a data transmission method according to an implementation of the present application.

FIG. 4 is a schematic flow chart of another data transmission method according to an implementation of the present application.

FIG. 5 is a schematic block diagram of a transmitting device according to an implementation of the present application.

FIG. 6 is a schematic block diagram of a receiving device according to an implementation of the present application.

FIG. 7 is a schematic block diagram of a data transmission device according to an implementation of the present application.

FIG. 8 is a schematic diagram of structure of a system chip according to an implementation of the present application.

### DETAILED DESCRIPTION

Technical solutions in implementations of the present application will be clearly and completely described below with reference to the drawings in the implementations of the present application.

The technical solutions of the implementations of the present application may be applied to various communication systems, such as a Global System of Mobile communication (GSM) system, a Code Division Multiple Access (CDMA) system, a Wideband Code Division Multiple Access (WCDMA) system, a General Packet wireless Service (GPRS) system, a Long Term Evolution (LTE) system, an LTE Frequency Division Duplex (FDD) system, an LTE Time Division Duplex (TDD) system, a Universal Mobile Telecommunication System (UMTS) system, a Worldwide Interoperability for Microwave Access (WiMAX) communication system, or a future 5G system.

FIG. 1 shows a wireless communication system 100 to which an implementation of the present application is applied. The wireless communication system 100 may include a network device 110. The network device 110 may be a device that communicates with a terminal device. The network device 110 may provide communication coverage for a specific geographical area, and may communicate with a terminal device (e.g., UE) in the coverage area. Optionally, the network device 110 may be a Base Transceiver Station (BTS) in a GSM system or CDMA system, a NodeB (NB) in a WCDMA system, an Evolutional Node B (eNB or eNodeB) in an LTE system, or a radio controller in a Cloud Radio Access Network (CRAN). Or the network device may be a relay station, an access point, a vehicle-mounted device, a wearable device, a network side device in a future 5G network, or a network device in a future evolved Public Land Mobile Network (PLMN), etc.

The wireless communication system 100 further includes at least one terminal device 120 in the coverage area of the network device 110. The terminal device 120 may be mobile or fixed. The terminal device 120 may be referred to as an access terminal, a User Equipment (UE), a subscriber unit, a subscriber station, a mobile station, a remote station, a remote terminal, a mobile device, a user terminal, a terminal, a wireless communication device, a user agent, or a user apparatus. The access terminal may be a cellular phone, a cordless phone, a Session Initiation Protocol (SIP) phone, a Wireless Local Loop (WLL) station, a Personal Digital Assistant (PDA), a handheld device with a wireless communication function, a computing device, or other processing device connected to a wireless modem, a vehicle-mounted device, a wearable device, a terminal device in a future 5G network, or a terminal device in a future evolved Public Land Mobile Network (PLMN), or the like.

Optionally, Device to Device (D2D) communication may be performed between the terminal devices 120.

Optionally, the 5G system or network may be referred to as a New Radio (NR) system or network.

FIG. 1 exemplifies one network device and two terminal devices. Optionally, the wireless communication system 100 may include multiple network devices, and another quantity of terminal devices may be included within the coverage area of each network device, which is not restricted in the implementations of the present application.

Optionally, the wireless communication system 100 may further include other network entities such as a network controller, a mobile management entity, which is not restricted in the implementations of the present application.

The process of mapping Quality of Service (QoS) flows to Data Radio Bearers (DRBs) in an implementation of the present application will be briefly described below with reference to FIG. 2. In the 5G system, an SDAP layer is added to an upper layer of a Packet Data Convergence Protocol (PDCP) layer on a Radio Access Network (RAN) side for accomplishing mapping of a QoS flow to a DRB. Specifically, as shown in FIG. 2, an Internet Protocol (IP) layer maps a data packet from an IP flow to a QoS flow, then the SDAP maps the data packet from the QoS flow to a radio bearer which specifically is a DRB. Different QoS flows may be mapped to a same DRB, and the data packet is delivered to the PDCP layer through the mapped DRB for processing. For an uplink data packet, the mapping of the QoS flow to the DRB may be directly indicated to a terminal through Radio Resource Control (RRC), or may be obtained through reflective QoS mapping. Specifically, a network device may carry an Identity (ID) of the QoS flow in all downlink data packets belonging to the same QoS flow. After successfully obtaining each downlink data packet, the terminal device may record the mapping of the QoS flow to the DRB. When there is an uplink data packet which needs to be sent, the terminal device directly sends the uplink data packet according to the recorded mapping relationship. Since in the existing solution, all the downlink data packets belonging to the same QoS flow need to carry the Identity of the QoS flow, it results in that network overhead is relatively large.

It should be understood that the terms “system” and “network” are often used interchangeably in this document. The term “and/or” in this document is merely an association relationship describing associated objects, indicating that there may be three relationships, for example, A and/or B may indicate three cases: A alone, A and B, and B alone. In addition, the symbol “/” in this document generally indicates that objects before and after the symbol “/” have an “or” relationship.

FIG. 3 is a schematic flow chart of a data transmission method 200 according to an implementation of the present application. As shown in FIG. 3, the method 200 may be performed by a transmitting device, which may be a network device as shown in FIG. 1 or a terminal device as shown in FIG. 1. A receiving device in the method 200 may be the network device as shown in FIG. 1 or the terminal device as shown in FIG. 1. The method 200 includes following contents.

In a transmission process of a Quality of Service flow, a data radio bearer corresponding to the Quality of Service (QoS) flow can be switched from a source data radio bearer to a target data radio bearer, and after the switching, data packets of the Quality of Service flow will not be out of order and the transmission will not be interrupted, and reliability of data transmission is ensured.

In 210, a transmitting device switches a Data Radio Bearer (DRB) corresponding to a first Quality of Service (QoS) flow from a first DRB to a second DRB.

Optionally, an SDAP within the transmitting device may switch the Data Radio Bearer (DRB) corresponding to the first QoS flow from the first DRB to the second DRB.

Optionally, a QoS Class Identifier (QCI) of a data packet transmitted on the second DRB is superior to a QCI of a data packet transmitted on the first DRB.

It should be understood that the higher a QCI of a data packet is, the higher a transmission rate of the data packet is.

Optionally, the first DRB may be a default DRB established by the Radio Access Network side, and all different QoS flows will be mapped to the default DRB.

Optionally, the second DRB is more suitable for a transmission requirement of the first QoS flow.

Therefore, in the data transmission method of the implementation of the present application, the transmitting device can switch the DRB corresponding to the first Quality of Service flow from the first DRB to the second DRB in the transmission process of the first Quality of Service flow, therefore, switching the first Quality of Service flow from the first DRB to the second DRB in the transmission process is implemented, and transmission efficiency of the first Quality of Service flow is improved.

Optionally, when the transmitting device is a network device, the network device may directly decide to switch the DRB corresponding to the first QoS flow from the first DRB to the second DRB.

Optionally, when the transmitting device is a terminal device, the transmitting device receives indication information, wherein the indication information is used for indicating switching the DRB corresponding to the first QoS flow from the first DRB to the second DRB, so that the transmitting device can switch the DRB corresponding to the first QoS flow from the first DRB to the second DRB according to the indication information.

Optionally, the indication information is a Radio Resource Control (RRC) signaling or Reflective QoS (RQoS), wherein the RQoS is determined according to an Identity (ID) of a data packet received on the second DRB.

Optionally, before the transmitting device switches the DRB corresponding to the first QoS flow from the first DRB to the second DRB, the method further includes: the transmitting device sends at least one data packet in the first QoS flow through the first DRB.

In 220, the transmitting device sends unseat data packets in the first QoS flow to the receiving device through the second DRB,

Optionally, the transmitting device may ensure that data packets of the first QoS flow transmitted through the first DRB and data packets of the first QoS flow transmitted through the second DRB are delivered in sequence (transmission reliability of the first QoS flow) by following modes.

In mode 1, before the transmitting device sends the at least one data packet in the first QoS flow through the first DRB, the transmitting device adds first identity information to a header of the last data packet in the at least one data packet, wherein the first identity information is used for indicating that the last data packet is the last data packet sent by the transmitting device through the first DRB.

Therefore, the receiving device can determine a sequence of the data packets in the first QoS flow according to the first identity information, and ensure transmission reliability of the first QoS flow.

Therefore, in the data transmission method of an implementation of the present application, the transmitting device can indicate the last data packet sent through the first DRB through the first identity information after switching the DRB corresponding to the first Quality of Service flow from the first DRB to the second DRB in the transmission process of the first Quality of Service flow, thereby ensuring that the first Quality of Service flow is not out of order in the transmission process and ensuring reliability of data transmission.

Optionally, the first identity information may be an end marker.

For example, the first identity information is added to an SDAP header.

In mode 2, the transmitting device sends a first identity packet after sending the at least one data packet, wherein the first identity packet is used for indicating that a previous data packet of the first identity packet is the last data packet corresponding to the first DRB.

Therefore, the receiving device can determine a sequence of the data packets in the first QoS flow according to the first identity packet, and ensure transmission reliability of the first QoS flow.

Optionally, the first identity packet may be a new data packet generated by the transmitting device after sending the at least one data packet.

For example, the first identity packet may be an SDAP Protocol Data Unit (PDU) without payload or an SDAP control PDU.

In mode 3, before the transmitting device sends the unsent data packets to the receiving device through the second DRB, the transmitting device adds second identity information to a header of the first data packet in the unsent data packets, wherein the second identity information is used for indicating that the transmitting device sends a data packet in the first QoS flow through the first DRB before sending the first data packet.

Therefore, the receiving device can determine a sequence of the data packets in the first QoS flow according to the second identity information, and ensure transmission reliability of the first QoS flow.

Optionally, the second identity information may be a start marker.

For example, the second identity information is added to an SDAP header.

In mode 4, before the transmitting device sends the unsent data packets to the receiving device through the second DRB, the transmitting device sends a second identity packet to the receiving device through the second DRB, wherein the second identity packet is used for indicating that the transmitting device sends a data packet in the first QoS flow through the first DRB before sending the second identity packet.

Therefore, the receiving device can determine a sequence of the data packets in the first QoS flow according to the second identity packet, and ensure transmission reliability of the first QoS flow.

Optionally, the second identity packet may be a new data packet generated by the transmitting device before sending the unsent data packets.

For example, the second identity packet may be an SDAP PDU without payload or an SDAP control PDU.

Optionally, the transmitting device may ensure that the data packets of the first QoS flow transmitted through the first DRB and the data packets of the first QoS flow transmitted through the second DRB are delivered in sequence (transmission reliability of the first QoS flow) according to at least one of the above four modes.

Therefore, in the data transmission method of an implementation of the present application, the transmitting device can indicate the last data packet sent through the first DRB through the first identity information after switching the DRB corresponding to the first QoS flow from the first DRB to the second DRB in the transmission process of the first QoS flow, thereby ensuring that the first QoS flow is not out of order in the transmission process, and ensuring reliability of data transmission.

Further, a QoS Class Identifier (QCI) of a data packet transmitted on the second DRB is superior to a QCI of a data packet transmitted on the first DRB, so that data transmission can be performed more efficiently after the DRB corresponding to the first QoS flow is switched from the first DRB to the second DRB.

Therefore, in the data transmission method of an implementation of the present application, the QoS Class Identifier (QCI) of the data packet transmitted on the second DRB is superior to the QCI: of the data packet transmitted on the first DRB, so that data transmission can be performed more efficiently after the DRB corresponding to the first Quality of Service flow is switched from the first DRB to the second DRB.

FIG. 4 is a schematic flow chart of a data transmission method 300 according to an implementation of the present application. As shown in FIG. 4, the method 300 may be performed by a receiving device, which may be a network device as shown in FIG. 1 or a terminal device as shown in FIG. 1. A transmitting device in the method 300 may be a network device as shown in FIG. 1 or a terminal device as shown in FIG. 1. The method 300 includes following contents.

In 310, a receiving device determines that a Data Radio Bearer (DRB) corresponding to a first Quality of Service (QoS) flow is switched from a first DRB to a second DRB.

Optionally, a QoS Class Identifier (QCI) of a data packet transmitted on the second DRB is superior to a QCI of a data packet transmitted on the first DRB.

Optionally, when the receiving device is a network device, the receiving device may directly determine that the Data Radio Bearer (DRB) corresponding to the first QoS flow is switched from the first DRB to the second DRB.

Optionally, when the receiving device is a terminal device, the receiving device receives indication information, wherein the indication information is used for indicating that the DRB corresponding to the first QoS flow is switched from the first DRB to the second DRB, and the receiving device may determine that the Data Radio Bearer (DRB) corresponding to the first QoS flow is switched from the first DRB to the second DRB according to the indication information.

Optionally, the indication information is a Radio Resource Control (RRC) signaling or a reflective quality of service, wherein the reflective quality of service is determined according to an Identity (ID) of a data packet received on the second DRB.

In 320, the receiving device receives multiple data packets in the first QoS flow sent by the transmitting device through the second DRB.

In 330, the receiving device buffers the multiple data packets.

Optionally, if the receiving device first receives data packets sent by the transmitting device through the first DRB, the receiving device directly delivers this part of data packets.

Optionally, if the receiving device first receives multiple data packets sent by the transmitting device through the second DRB, the receiving device buffers the multiple data packets.

Specifically, whether to buffer the multiple data packets may be determined according to following two modes.

In mode 1, a packet header of the first data packet in the multiple data packets includes first identity information, wherein the first identity information is used for indicating that the transmitting device sends a data packet in the first QoS flow through the first DRB before sending the first data packet. At this case, the receiving device may determine that the multiple data packets need to be buffered according to the first identity information.

Optionally, the first identity information may be a start marker.

For example, the first identity information is added to an SDAP header.

In mode 2, before the receiving device receives the multiple data packets, the receiving device receives a first identity packet through the second DRB, wherein the first identity packet is used for indicating that the transmitting device sends a data packet in the first QoS flow through the first DRB before sending the first identity packet. At this case, the receiving device may determine that the multiple data packets need to be buffered according to the first identity packet.

Optionally, the first identity packet may be a new data packet generated by the transmitting device before sending the multiple data packets.

For example, the first identity packet may be an SDAP PDU without payload or an SDPA control PDU.

Optionally, the method 300 further includes: the receiving device receives at least one data packet in the first QoS flow sent by the transmitting device through the first DRB, wherein a header of the last data packet in the at least one data packet includes second identity information for indicating that the last data packet is the last data packet sent by the transmitting device through the first DRB; the receiving device transmits the multiple data packets received through the second DRB and the at least one data packet received through the first DRB according to the second identity information.

Therefore, in the data transmission method of an implementation of the present application, after determining that the DRB corresponding to the first Quality of Service flow is switched from the first DRB to the second DRB, the receiving device can indicate the last data packet sent through the first DRB through the second identity information, thus ensuring that the first Quality of Service flow is not out of order in the transmission process, and then ensuring reliability of data transmission.

Optionally, the second identity information may be an end marker.

For example, the second identity information is added to an SDAP header.

Optionally, the method 300 further includes: the receiving device receives at least one data packet in the first QoS flow sent by the transmitting device through the first DRB; the receiving device receives a second identity packet sent by the transmitting device through the first DRB, wherein the second identity packet is used for indicating that a previous data packet of the second identity packet is the last data packet sent by the transmitting device through the first DRB; the receiving device transmits the multiple data packets received through the second DRB and the at least one data packet received through the first DRB according to the second identity packet.

Optionally, the second identity packet may be a new data packet generated by the transmitting device after sending the at least one data packet.

For example, the second identity packet may be an SDAP PDU without payload or an SDAP control PDU.

It should be understood that the acts in the data transmission method 300 may refer to the description of corresponding acts in the data transmission method 200, and will not be repeated here for the sake of brevity.

Therefore, in the data transmission method of an implementation of the present application, the receiving device can determine that the DRB corresponding to the first QoS flow is switched from the first DRB to the second DRB in the transmission process of the first QoS flow, and after receiving the multiple data packets in the first QoS flow transmitted by the transmitting device through the second DRB, buffer these data packets, thereby ensuring that the first QoS flow is not out of order in the transmission process, and then ensuring reliability of the data transmission.

Further, after the receiving device determines that the DRB corresponding to the first QoS flow is switched from the first DRB to the second DRB, the last data packet sent through the first DRB may be indicated through the second identity information, thereby ensuring that the first QoS flow is not out of order in the transmission process, and then ensuring reliability of the data transmission.

Further, a QoS Class Identifier (QCI) of a data packet transmitted on the second DRB is superior to a QCI of a data packet transmitted on the first DRB, so that data transmission can be performed more efficiently after the DRB corresponding to the first QoS flow is switched from the first DRB to the second DRB.

Therefore, in the data transmission method of an implementation of the present application, the QoS Class Identifier (QCI) of the data packet transmitted on the second DRB is superior to the QCI of the data packet transmitted on the first DRB, so that data transmission can be performed more efficiently after the DRB corresponding to the first Quality of Service flow is switched from the first DRB to the second DRB.

FIG. 5 is a schematic block diagram of a transmitting device 400 according to an implementation of the present application. As shown in FIG. 5, the transmitting device 400 includes: a processing unit 410, used for switching a Data Radio Bearer (DRB) corresponding to a first Quality of Service (QoS) flow from a first DRB to a second DRB; a sending unit 420, used for sending unsent data packets in the first QoS flow to a receiving device through the second DRB.

Optionally, before the processing unit 410 switches the DRB corresponding to the first QoS flow from the first DRB to the second DRB, the transmitting device 400 further includes: a receiving unit 430, used for receiving indication information, the indication information is used for indicating switching the DRB corresponding to the first QoS flow from the first DRB to the second DRB.

Optionally, the indication information is a Radio Resource Control (RRC) signaling or a Reflective Quality of Service (RQoS), wherein the RQoS is determined according to an Identity (ID) of a data packet received on the second DRB.

Optionally, before the processing unit 410 switches the DRB corresponding to the first QoS flow from the first DRB to the second DRB, the sending unit 420 is further used for sending at least one data packet in the first QoS flow through the first DRB.

Optionally, before the sending unit 420 sends the at least one data packet in the first QoS flow through the first DRB, the processing unit 410 is further used for adding first identity information to a header of the last data packet in the at least one data packet, wherein the first identity information is used for indicating that the last data packet is the last data packet sent by the transmitting device through the first DRB.

Optionally, the sending unit 420 is further used for sending a first identity packet after sending the at least one data packet, wherein the first identity packet is used for indicating that a previous data packet of the first identity packet is the last data packet corresponding to the first DRB.

Optionally, before the sending unit 420 sends the unsent data packets to the receiving device through the second DRB, the processing unit 410 is further used for adding second identity information to a header of the first data packet in the unsent data packets, wherein the second identity information is used for indicating that the transmitting device sends a data packet in the first QoS flow through the first DRB before sending the first data packet.

Optionally, before the sending unit 420 sends the unsent data packets to the receiving device through the second DRB, the sending unit 420 is further used for sending a second identity packet to the receiving device through the second DRB, wherein the second identity packet is used for indicating that the transmitting device sends a data packet in the first QoS flow through the first DRB before sending the second identity packet.

Optionally, a QoS Glass Identifier (QCI) of a data packet transmitted on the second DRB is superior to a QCI of a data packet transmitted on the first DRB.

It should be understood that the transmitting device 400 according to the implementation of the present application may correspond to the transmitting device in the method implementation of the present application, and the above and other operations and/or functions of various units in the transmitting device 400 are respectively for implementing the corresponding processes of the transmitting device in the method 200 shown in FIG. 3, and will not be repeated here for the sake of brevity.

FIG. 6 is a schematic block diagram of a receiving device 500 according to an implementation of the present application. As shown in FIG. 6, the receiving device 500 includes: a processing unit 510, used for determining that a Data Radio Bearer (DRB) corresponding to a first Quality of Service (QoS) flow is switched from a first DRB to a second DRB; a receiving unit 520, used for receiving multiple data packets in the first QoS flow sent by a transmitting device through the second DRB; a processing unit 510, further used for buffering the multiple data packets.

Optionally, before the processing unit 510 determines that the DRB corresponding to the first QoS flow is switched from the first DRB to the second DRB, the receiving unit 520 is further used for receiving indication information, wherein the indication information is used for indicating that the DRB corresponding to the first QoS flow is switched from the first DRB to the second DRB.

Optionally, the indication information is a Radio Resource Control (RRC) signaling or a reflective quality of service, which is determined according to an Identity (ID) of a data packet received on the second DRB.

Optionally, a header of the first data packet in the multiple data packets includes first identity information, wherein the first identity information is used for indicating that the transmitting device sends a data packet in the first QoS flow through the first DRB before sending the first data packet; the processing unit 510 is further used for determining that the multiple data packets need to be buffered according to the first identity information.

Optionally, before the receiving unit 520 receives the multiple data packets, the receiving unit 520 is further used for receiving a first identity packet through the second DRB, wherein the first identity packet is used for indicating that the transmitting device sends a data packet in the first QoS flow through the first DRB before sending the first identity packet; the processing unit 510 is further used for determining that the multiple data packets need to be buffered according to the first identity packet.

Optionally, the receiving unit 520 is further used for receiving at least one data packet in the first QoS flow sent by the transmitting device through the first DRB, wherein a header of the last data packet in the at least one data packet includes second identity information, and the second identity information is used for indicating that the last data packet is the last data packet sent by the transmitting device through the first DRB; the receiving device 500 further includes: a sending unit 530, used for transmitting the multiple data packets received through the second DRB and the at least one data packet received through the first DRB according to the second identity information.

Optionally, the receiving unit 520 is further used for receiving at least one data packet in the first QoS flow sent by the transmitting device through the first DRB; the receiving unit 520 is further used for receiving a second identity packet sent by the transmitting device through the first DRB, wherein the second identity packet is used for indicating that a previous data packet of the second identity packet is the last data packet sent by the transmitting device through the first DRB; the receiving device 500 further includes: a sending unit 530, used for transmitting the multiple data packets received through the second DRB and the at least one data packet received through the first DRB according to the second identity packet.

Optionally, a QoS Class Identifier (QCI) of a data packet transmitted on the second DRB is superior to a QCI of a data packet transmitted on the first DRB.

It should be understood that the receiving device 500 according to the implementation of the present application may correspond to the terminal device in the method implementation of the present application, and the above and other operations and/or functions of various units in the receiving device 500 are respectively for implementing the corresponding processes of the receiving device in the method 300 shown in FIG. 4, and will not be repeated here for the sake of brevity.

FIG. 7 shows a schematic block diagram of a data transmission device 600 according to an implementation of the present application. The device 600 includes: a memory 610, used for storing a program, wherein the program includes codes; a transceiver 620, used for communicating with other devices; and a processor 630, used for executing the codes of the program in the memory 610.

Optionally, When the codes are executed, the processor 630 may implement various operations performed by the transmitting device in the method 200 in FIG. 3, which will not be repeated here for brevity. At this case, the device 600 may be a network device (e.g., an access network device or a core network device) or a terminal device (e.g., a cell phone). The transceiver 620 is used for performing specific transmitting and receiving of signals under the driving of the processor 630.

Optionally, when the codes are executed, the processor 630 may also implement various operations performed by the receiving device in the method 300 in FIG. 4, which will not be repeated here for brevity. At this case, the device 600 may be a terminal device (e.g., a cell phone) or a network device an access network device or a core network device).

It should be understood that in the implementation of the present application, the processor 630 may be a Central Processing Unit (CPU), or the processor 630 may be other general purpose processors, digital signal processors (DSP), application specific integrated circuits (ASIC), Field programmable gate arrays (FPGA) or other programmable logic devices, discrete gate or transistor logic devices, discrete hardware components, etc. The general purpose processor may be a microprocessor or the processor may be any conventional processor or the like.

The memory 610 may include a read-only memory and a random access memory, and provide instructions and data to the processor 630. A portion of the memory 610 may include a non-volatile random access memory. For example, the memory 610 may also store type information of a device.

The transceiver 620 may be used for implementing signal transmission and reception functions, such as frequency modulation and demodulation functions, or up-conversion and down-conversion functions.

In the implementation process, at least one act of the method may be accomplished by an integrated logic circuit of hardware in the processor 630, or the integrated logic circuit may accomplish the at least one act under the driving of instructions in a form of software. Therefore, the data transmission device 600 may be a chip or a chipset. The acts of the method disclosed in connection with the implementation of the present application may be directly embodied to be accomplished by an execution of a hardware processor or by a combination of hardware and software modules in a processor. The software modules may be located in a storage medium commonly used in the art, such as a random access memory, a flash memory, a read-only memory, a programmable read-only memory or an electrically erasable programmable memory, or a register. The storage medium is located in the memory, and the processor 630 reads the information in the memory and accomplishes the acts of the method with its hardware. In order to avoid repetition, it will not be described in detail here.

FIG. 8 is a schematic block diagram of a system chip 700 according to an implementation of the present application. The system chip 700 of FIG. 8 includes an input interface 701, an output interface 702, a processor 703 and a memory 704, and the processor 703 and the memory 704 may be connected through internal communication connection lines, and the processor 1503 is used for executing codes in the memory 1504.

Optionally, when the codes are executed, the processor 703 implements the method performed by the transmitting device in the method implementation. For sake of conciseness, the specific description will not be repeated here.

Optionally, when the codes are executed, the processor 703 implements the method performed by the receiving device in the method implementation. For sake of conciseness, the specific description will not be repeated here.

Those of ordinary skill in the art will recognize that the exemplary units and algorithm acts described in connection with the implementations disclosed herein may be implemented in electronic hardware, or a combination of computer software and electronic hardware. Whether these functions are implemented in hardware or software depends on a specific application and design constraint of the technical solution. Those skilled in the art may use different manners to implement the described functions for each particular application, but such implementation should not be considered to be beyond the scope of the present application.

Those skilled in the art may clearly understand that for convenience and conciseness of description, the specific working process of the system, device and unit described above may refer to the corresponding process in the implementations of methods described above, and details are not described herein again.

In several implementations provided by the present application, it should be understood that the disclosed system, device and method may be implemented in other ways. For example, the apparatus implementations described above are only illustrative, for another example, the division of the units is only a logical function division, and there may be other division manners in actual implementation. For still another example, multiple units or components may be combined or integrated into another system, or some features may be ignored or not executed. On the other hand, the mutual coupling or direct coupling or communication connection shown or discussed may be indirect coupling or communication connection through some interfaces, devices or units, and may be in electrical, mechanical or other forms.

The units described as separated components may or may not be physically separated, and the component shown as a unit may or may not be a physical unit, i.e., it may be located in one place or may be distributed over multiple network units. Some or all of the units may be selected according to practical needs to achieve a purpose of the solution of the implementations.

In addition, various functional units in various implementations of the present application may be integrated in one processing unit, or various units may be physically present separately, or two or more units may be integrated in one unit.

The functions may be stored in a computer readable storage medium if implemented in a form of a software functional unit and sold or used as a separate product. Based on this understanding, the technical solution of the present application, in essence, or the part contributing to the existing art, or the part of the technical solution, may be embodied in the form of a software product stored in a storage medium, including several instructions for causing a computer device (which may be a personal computer, a server, or a network device, etc.) to perform all or part of the acts of the methods described in various implementations of the present application. The aforementioned storage media include a U disk, a mobile hard disk, read-only memory (ROM), a random access memory (RAM), a magnetic disk or an optical disk, and other media that is capable of storing program codes.

The foregoing are merely exemplary implementations of the present application, but the protection scope of the present application is not limited thereto. Any person skilled in the art may easily conceive variations or substitutions within the technical scope disclosed by the present application, which should be included within the protection scope of the present application. Therefore, the protection scope of the present application should be subject to the protection scope of the claims.

1. A method for data transmission, comprising:
switching, by a transmitting device, a Data Radio Bearer (DRB) corresponding to a first Quality of Service (QoS) flow from a first DRB to a second DRB; and
sending, by the transmitting device, unsent data packets in the first QoS flow to a receiving device through the second DRB.

2. The method according to claim 1, wherein before the transmitting device switches the DRB corresponding to the first QoS flow from the first DRB to the second DRB, the method further comprises:
receiving, by the transmitting device, indication information, wherein the indication information is used for indicating switching the DRB corresponding to the first QoS flow from the first DRB to the second DRB.

3. The method according to claim 2, wherein the indication information is a Radio Resource Control (RRC) signaling or a Reflective Quality of Service (RQoS), wherein the RQoS is determined according to an Identity (ID) of a data packet received on the second DRB.

4. The method according to claim 1, wherein before the transmitting device switches the DRB corresponding to the first QoS flow from the first DRB to the second DRB, the method further comprises:
sending, by the transmitting device, at least one data packet in the first QoS flow through the first DRB.

5. (canceled)

6. The method according to claim 4, wherein the method further comprises:
sending, by the transmitting device, a first identity packet after sending the at least one data packet, wherein the first identity packet is used for indicating that a previous data packet of the first identity packet is a last data packet corresponding to the first DRB.

7-9. (canceled)

10. A method for data transmission, comprising:
determining, by a receiving device, that a Data Radio Bearer (DRB) corresponding to a first Quality of Service (QoS) flow is switched from a first DRB to a second DRB; and
receiving, by the receiving device, a plurality of data packets in the first QoS flow sent by a transmitting device through the second DRB.

11. The method according to claim 10, wherein before the receiving device determines that the DRB corresponding to the first QoS flow is switched from the first DRB to the second DRB, the method further comprises:
receiving, by the receiving device, indication information, wherein the indication information is used for indicating that the DRB corresponding to the first QoS flow is switched from the first DRB to the second DRB.

12. The method according to claim 11, wherein the indication information is a Radio Resource Control (RRC) signaling or a Reflective Quality of Service (RQoS), wherein the RQoS is determined according to an Identity (ID) of a data packet received on the second DRB.

13. The method according to claim 10, wherein a Service Data Adaptation Protocol (SDAP) control Protocol Data Unit (PDU) comprises first identity information, wherein the first identity information is used for indicating that the transmitting device sends a data packet in the first QoS flow through the first DRB before sending a first data packet;
the receiving device determines that the plurality data packets need to be buffered, which comprises:
determining that the plurality of data packets need to be buffered according to the first identity information; and
the method further comprises: buffering, by the receiving device, the plurality of data packets.

14. (canceled)

15. The method according to claim 10, wherein the method further comprises:
receiving, by the receiving device, at least one data packet in the first QoS flow sent by the transmitting device through the first DRB, wherein a header of a last data packet in the at least one data packet comprises second identity information, and the second identity information is used for indicating that the last data packet is a last data packet sent by the transmitting device through the first DRB; and
transmitting, by the receiving device, the plurality of data packets received through the second DRB and the at least one data packet received through the first DRB according to the second identity information.

16. (canceled)

17. (canceled)

18. A transmitting device, comprising:
a processor, configured for switching a Data Radio Bearer (DRB) corresponding to a first Quality of Service (QoS) flow from a first DRB to a second DRB; and
a transceiver, configured for sending unsent data packets in the first QoS flow to a receiving device through the second DRB.

19. The transmitting device according to claim 18, wherein before the processor switches the DRB corresponding to the first QoS flow from the first DRB to the second DRB,
the transceiver is further configured for receiving indication information, wherein the indication information is used for indicating switching the DRB corresponding to the first QoS flow from the first DRB to the second DRB.

20. The transmitting device according to claim 19, wherein the indication information is a Radio Resource Control (RRC) signaling or a Reflective Quality of Service (RQoS), wherein the RQoS is determined according to an Identity (ID) of a data packet received on the second DRB.

21. The transmitting device according to claim 18, wherein the transceiver is further configured for sending at least one data packet in the first QoS flow through the first DRB before the processor switches the DRB corresponding to the first QoS flow from the first DRB to the second DRB.

22. (canceled)

23. The transmitting device according to claim 21, wherein the transceiver is further configured for sending a first identity packet after sending the at least one data packet, wherein the first identity packet is configured for indicating that a previous data packet of the first identity packet is a last data packet corresponding to the first DRB.

24-26. (canceled)

27. A receiving device, comprising:
a processor, configured for determining that a Data Radio Bearer (DRB) corresponding to a first Quality of Service (QoS) flow is switched from a first DRB to a second DRB; and
a transceiver configured for receiving a plurality of data packets in the first QoS flow sent by a transmitting device through the second DRB.

28. The receiving device according to claim 27, wherein before the processor determines that the DRB corresponding to the first QoS flow is switched from the first DRB to the second DRB, the transceiver is further configured for receiving indication information, wherein the indication information is used for indicating that the DRB corresponding to the first QoS flow is switched from the first DRB to the second DRB.

29. The receiving device according to claim 28, wherein the indication information is a Radio Resource Control (RRC) signaling or a Reflective Quality of Service (RQoS), wherein the RQoS is determined according to an Identity (ID) of a data packet received on the second DRB.

30. The receiving device according to claim 27, wherein a Service Data Adaptation Protocol (SDAP) control Protocol Data Unit (PDU) comprises first identity information, wherein the first identity information is used for indicating that the transmitting device sends a data packet in the first QoS flow through the first DRB before sending a first data packet; and
the processor is further configured for determining that the plurality of data packets need to be buffered according to the first identity information and buffering the plurality of data packets.

31. (canceled)

32. The receiving device according to claim 27, wherein,
the transceiver is further configured for receiving at least one data packet in the first QoS flow sent by the transmitting device through the first DRB, wherein a header of a last data packet in the at least one data packet comprises second identity information, and the second identity information is used for indicating that the last data packet is a last data packet sent by the transmitting device through the first DRB; and
the transceiver is configured for transmitting the plurality of data packets received through the second DRB and the at least one data packet received through the first DRB according to the second identity information.

33. (canceled)

34. (canceled)

35. The method according to claim 6, wherein the first identity packet is a Service Data Adaptation Protocol (SDAP) control Protocol Data Unit (PDU).

36. The transmitting device according to claim 23, wherein the first identity packet is a Service Data Adaptation Protocol (SDAP) control Protocol Data Unit (PDU).
